(19) United States
(12) Patent Application Publication
(10) Pub. No.: US 2022/0285805 A1
(43) Pub. Date: Sep. 8, 2022

(54) SECONDARY BATTERY

(71) Applicant: Prime Planet Energy & Solutions, Inc., Tokyo (JP)

(72) Inventor: Takayuki HOJO, Nagoya-shi (JP)

(21) Appl. No.: 17/684,370

(22) Filed: Mar. 1, 2022

(30) Foreign Application Priority Data
Mar. 3, 2021 (JP) 2021-033412

(51) Int. Cl. H01M 50/595; H01M 10/0587; H01M 10/052; H01M 50/474; H01M 4/36; H01M 4/62; H01M 50/586

(52) U.S. Cl. CPC H01M 50/595; H01M 10/0587; H01M 10/052; H01M 50/474; H01M 4/366; H01M 4/622; H01M 50/586

(57) ABSTRACT

Provided is a technique capable of suppressing the precipitation of metallic lithium on a negative electrode active material layer. A secondary battery that is disclosed herein includes a wound electrode body in which a long sheet-shaped positive electrode sheet and a long sheet-shaped negative electrode sheet are wound in a longitudinal direction, with a separator being interposed therebetween and a non-aqueous electrolytic solution. At least one end portion of the positive electrode sheet in the longitudinal direction is provided with an insulating tape that covers the end portion and is attached onto a positive electrode active material layer and a coating that is provided on the positive electrode active material layer along the edge of the insulating tape and is inactive to a battery reaction. Here, a thickness of the coating decreases gradually as a distance between the coating and the edge of the insulating tape increases gradually.

### CROSS REFERENCE TO RELATED APPLICATIONS

The present invention claims a priority based on Japanese Patent Application No. 2021-033412, filed on Mar. 3, 2021, the entire content of which is incorporated into the present specification by reference.

### BACKGROUND OF THE INVENTION

### 1. Technical Field

The present invention relates to a secondary battery.

### 2. Background

For example, Japanese Patent Application Publication No. 2019-164942 relates to a non-aqueous electrolyte secondary battery and discloses a mode in which an insulating tape is attached to an end portion of a positive electrode plate. In the publication, the insulating tape has a base material and a pressure-sensitive adhesive layer provided on the base material and has a non-pressure-sensitive adhesive region where no pressure-sensitive adhesive layer is formed on the base material. In addition, a lithium deintercalation suppression portion where the deintercalation of lithium ions is suppressed is provided in a positive electrode mixture layer that is positioned in the vicinity of an end portion of the non-pressure-sensitive region on the base material. The lithium deintercalation suppression portion may be formed by locally increasing the filling density of the positive electrode mixture layer. Specifically, the filling density of the positive electrode mixture layer can be locally increased by, in a step of rolling the positive electrode mixture layer at the time of manufacturing the positive electrode plate, applying a higher pressing pressure to a portion of the positive electrode mixture layer that is to serve as the lithium deintercalation suppression portion than other portions or performing a larger number of times of rolling on the portion than other portions. When the filling density is locally increased as described above, a gap that is included in the lithium deintercalation suppression portion becomes small, which makes it difficult for an electrolytic solution to intrude into the inside. Then, the deintercalation of lithium ions becomes difficult, and consequently, the precipitation of metallic lithium is suppressed at the position of a negative electrode mixture layer that faces the lithium deintercalation suppression portion.

### SUMMARY OF THE INVENTION

Incidentally, in secondary batteries where an insulating tape is attached to a terminal portion of a positive electrode sheet in a winding direction of a wound electrode body, it is preferable to suppress the precipitation of metallic lithium on a facing negative electrode active material layer. Here, a new method that is different from the above-described publication will be proposed.

A secondary battery that is disclosed herein includes a wound electrode body in which a positive electrode sheet having a long sheet-shaped positive electrode current collector and a positive electrode active material layer formed on a surface of the positive electrode current collector and a negative electrode sheet having a long sheet-shaped negative electrode current collector and a negative electrode active material layer formed on a surface of the negative electrode current collector are wound in a longitudinal direction, with a separator being interposed therebetween and a non-aqueous electrolytic solution. In the secondary battery, at least one end portion of the positive electrode sheet in the longitudinal direction is provided with an insulating tape that covers the end portion and is attached onto the positive electrode active material layer, and a coating that is provided on the positive electrode active material layer along an edge of the insulating tape and is inactive to a battery reaction. Here, a thickness of the coating decreases gradually as a distance between the coating and the edge of the insulating tape increases gradually.

In the positive electrode sheet provided in the secondary battery, the insulating tape is attached to at least one end portion of the sheet in the longitudinal direction, and the coating is provided along the insulating tape. The thickness of the coating decreases gradually as the distance between the coating and the edge of the insulating tape increases gradually. This makes it possible to suppress the precipitation of metallic lithium in the facing negative electrode active material layer.

In a preferable aspect of the secondary battery that is disclosed herein, the insulating tape and the coating are provided at both ends of the positive electrode sheet in the longitudinal direction. Such a configuration makes it possible to more favorably realize the effect of a technique that is disclosed herein.

In another preferable aspect of the secondary battery that is disclosed herein, a filler layer including an inorganic filler and a resin binder and/or a resin layer composed of a resin binder are provided as the coating. The effect of the technique that is disclosed herein can be preferably realized in the secondary battery including the filler layer and/or the resin layer as the coating.

In still another preferable aspect of the secondary battery that is disclosed herein, the resin binder is composed of at least one resin material selected from the group consisting of an acrylic resin and a vinyl halide resin. Such a configuration makes it possible for the effect of the technique that is disclosed herein to be appropriately realized.

### BRIEF DESCRIPTION OF THE DRAWINGS

FIG. 1 is a cross-sectional view schematically showing the internal structure of a secondary battery according to an embodiment;

FIG. 2 is a schematic exploded view showing the configuration of a wound electrode body of the secondary battery according to the embodiment;

FIG. 3 is a plan view of a positive electrode sheet that is used in the secondary battery according to the embodiment; and

FIG. 4 is an enlarged cross-sectional view of a main part schematically showing the laminate structure of the wound electrode body that is used in the secondary battery according to the embodiment.

### DETAILED DESCRIPTION OF THE PREFERRED EMBODIMENTS

Hereinafter, an embodiment of a technique that is disclosed herein will be described with reference to figures. The following embodiment is not intended to limit the technique that is disclosed herein. In addition, a matter that is not particularly mentioned in the present specification, but is required to perform the technique that is disclosed herein can be understood as a design item by a person skilled in the art based on the conventional art in the field. That is, the technique that is disclosed herein can be performed based on the contents that are disclosed in the present specification and technical common sense in the field.

In the figures to be referenced in the following description, members and portions exhibiting the same action will be given the same reference sign. Furthermore, dimensional relationships (length, width, thickness and the like) in each figure do not reflect actual dimensional relationships. In addition, a reference sign X in each figure indicates the “width direction” of an electrode body 20, a reference sign Y indicates the “longitudinal direction” of a positive electrode sheet 50 (negative electrode sheet 60) in the electrode body 20, and a reference sign Z indicates the “laminate direction” of the sheets. Here, these directions are defined for the convenience of description and are not intended to limit the installation aspects of secondary batteries in use or in production. In addition, the expression “A to B” that indicates a numerical range in the present specification means “A or more and B or less” and also means “more than A and less than B”.

In addition, “secondary battery” in the present specification generally refers to a storage device in which charge carriers migrate between a pair of electrodes (a positive electrode and a negative electrode) through an electrolyte to cause a charge and discharge reaction. Examples of such a secondary battery include not only so-called storage batteries such as a lithium-ion secondary battery, a nickel-hydrogen battery and a nickel-cadmium battery but also capacitors such as an electric double layer capacitor and the like. In addition, “active material” in the present specification refers to a substance that causes battery reactions, specifically, a compound capable of reversibly absorbing and desorbing chemical species (lithium ions in lithium-ion secondary batteries) that serve as charge carriers. Hereinafter, the embodiment of the technique that is disclosed herein will be described in detail using a flat square lithium-ion secondary battery as an example, which does not intend to limit the technique that is disclosed herein to such an embodiment.

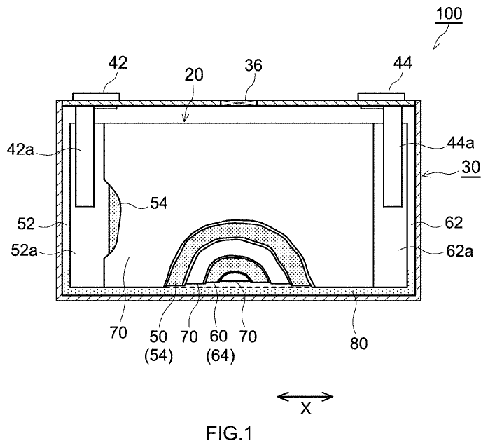

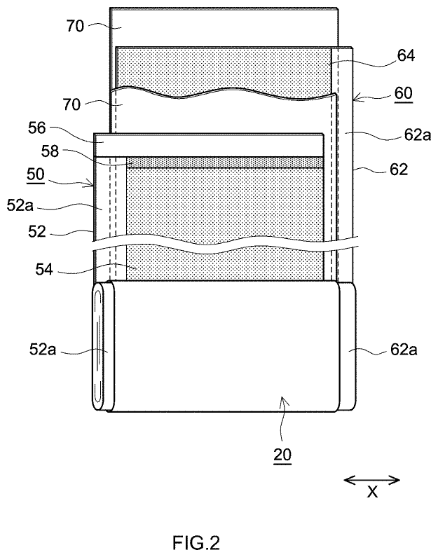

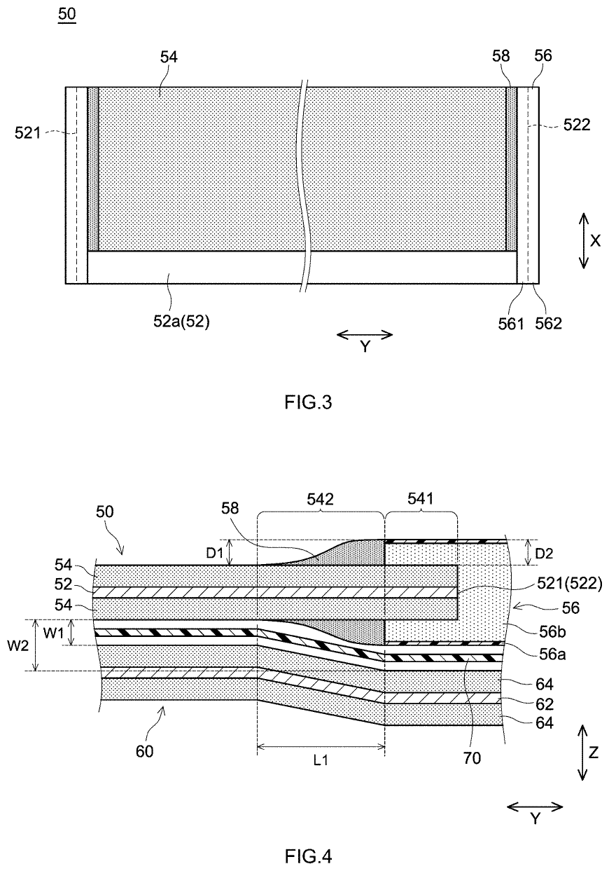

Hereinafter, the structure of a secondary battery that is disclosed herein will be described in detail with reference to FIGS. 1 to 4. FIG. 1 is a cross-sectional view schematically showing the internal structure of a secondary battery according to an embodiment. FIG. 2 is a schematic exploded view showing the configuration of a wound electrode body of the secondary battery according to the embodiment. FIG. 3 is a plan view of a positive electrode sheet that is used in the secondary battery according to the embodiment. FIG. 4 is an enlarged cross-sectional view of a main part schematically showing the laminate structure of the wound electrode body that is used in the secondary battery according to the embodiment.

As shown in FIG. 1, a secondary battery 100 is a sealed battery that is assembled by accommodating a flat wound electrode body 20 (hereinafter, also simply referred to as “electrode body 20”) and a non-aqueous electrolytic solution 80 in a flat square battery case (that is, an exterior container) 30.

In the battery case 30, a positive electrode terminal 42 and a negative electrode terminal 44, which are for external connection, and a thin safety valve 36 set to release the internal pressure of the battery case 30 in a case where the internal pressure rises to a predetermined level or higher are provided. In addition, in the battery case 30, an injection port (not shown) for injecting the non-aqueous electrolytic solution 80 is provided. The positive electrode terminal 42 is electrically connected to a positive electrode current collector plate 42a. The negative electrode terminal 44 is electrically connected to a negative electrode current collector plate 44a. As a material of the battery case 30, for example, a highly thermal conductive lightweight metallic material such as aluminum is used.

The non-aqueous electrolytic solution 80 typically contains a non-aqueous solvent and a supporting electrolyte. As the non-aqueous solvent and the supporting electrolyte, a variety of solvents that can be used for electrolytic solutions for this type of secondary batteries (here, a lithium-ion secondary battery) can be used with no limitations. Examples of the non-aqueous solvent include carbonates such as ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC) and trifluorodimethyl carbonate (TFDMC). Such non-aqueous solvents can be used singly or two or more non-aqueous solvents can be used in appropriate combination.

As the supporting electrolyte, for example, a lithium salt such as LiPF₆, LiBF₄ or LiClO₄ (preferably LiPF₆) can be used. The concentration of the supporting electrolyte needs to be set to 0.7 mol/L or higher and 1.3 mol/L or lower. In addition, the non-aqueous electrolytic solution 80 may contain well-known conventional additives such as a coating-forming agent such as an oxalate complex compound containing a boron (B) atom and/or a phosphorus (P) atom (for example, lithium bis(oxalato)borate (LiBOB)) or lithium difluorophosphate; a viscosity improver; and a dispersant as necessary. The amount of the non-aqueous electrolytic solution 80 in FIG. 1 does not strictly indicate the amount of the non-aqueous electrolytic solution 80 that is injected into the battery case 30.

As shown in FIGS. 1 and 2, the electrode body 20 has a form in which a positive electrode sheet 50 having positive electrode active material layers 54 formed along the longitudinal direction Y on one surface or both surfaces (herein, both surfaces) of a long sheet-shaped positive electrode current collector 52 and a negative electrode sheet 60 having negative electrode active material layers 64 formed along the longitudinal direction Y on one surface or both surfaces (herein, both surfaces) of a long sheet-shaped negative electrode current collector 62 are overlapped through two long sheet-shaped separators 70 and wound in the longitudinal direction. The positive electrode current collector plate 42a and the negative electrode current collector plate 44a are respectively joined to a positive electrode active material layer-free portion 52a (that is, a portion on which the positive electrode active material layer 54 is not formed and the positive electrode current collector 52 is exposed) and a negative electrode active material layer-free portion 62a (that is, a portion on which the negative electrode active material layer 64 is not formed and the negative electrode current collector 62 is exposed) provided so as to project outwards from both ends of the electrode body 20 in a winding axis direction (that is, the sheet width direction X orthogonal to the longitudinal direction).

Examples of the negative electrode current collector 62 that configures the negative electrode sheet 60 include a copper foil and the like. The negative electrode active material layer 64 contains at least a negative electrode active material. As the negative electrode active material, for example, a carbon material such as graphite, hard carbon or soft carbon can be used, and graphite is preferable. The negative electrode active material layer 64 may contain a component other than the active material, for example, a binder, a viscosity improver or the like. As the binder, for example, styrene butadiene rubber (SBR) or the like can be used. As the viscosity improver, for example, carboxymethyl cellulose (CMC) or the like can be used.

Examples of the separator 70 include porous sheets (films) composed of a resin such as polyethylene (PE), polypropylene (PP), polyester, cellulose or a polyamide. Such a porous sheet may have a single-layer structure or may have a laminate structure of two or more layers (for example, a three-layer structure including PP layers laminated on both surfaces of a PE layer). A heat-resistant layer (HRL) may be provided on the surface of the separator 70.

Examples of the positive electrode current collector 52 that configures the positive electrode sheet 50 include an aluminum foil and the like. The positive electrode active material layer 54 contains at least a positive electrode active material. Examples of the positive electrode active material include lithium transition metal oxides (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄ and the like), lithium transition metal phosphate compounds (for example, LiFePO₄ and the like) and the like. The positive electrode active material layer 54 may contain a component other than the active material, for example, a conductive material, a binder or the like. As the conductive material, for example, carbon black such as acetylene black (AB) or a different carbon material (for example, graphite or the like) can be preferably used. As the binder, for example, polyvinylidene fluoride (PVDF) or the like can be used.

As shown in FIGS. 2 and 3, an insulating tape 56 and a coating 58 are provided in at least one end portion of the positive electrode sheet 50 in the longitudinal direction Y. One end portion of the positive electrode sheet 50 in the longitudinal direction Y is a first end portion 521 where the winding of the positive electrode sheet 50 begins and is positioned on the innermost side of the electrode body 20. The other end portion that is different from the first end portion 521 is a second end portion 522 where the winding of the positive electrode sheet 50 ends and is positioned on the outside compared with the first end portion 521. The first end portion 521 and the second end portion 522 are both terminal portions of the positive electrode sheet 50 in the winding direction of the electrode body 20.

In the present embodiment, as shown in FIG. 3, the insulating tapes 56 and the coatings 58 are provided in both the first end portion 521 and the second end portion 522, but the configuration is not limited thereto as long as the insulating tape 56 and the coating 58 are provided in at least any one of the first end portion 521 and the second end portion 522. Hereinafter, a case where the insulating tape 56 and the coating 58 are provided in the first end portion 521 will be described in detail, but the detailed description of a case where the insulating tape 56 and the coating 58 are provided in the second end portion 522 is also basically the same and thus will not be repeated.

As shown in FIG. 4, the insulating tape 56 includes, for example, a base 56a and an adhesive layer 56b provided on the surface (typically, single surface) of the base. The base 56a is not particularly limited, and a variety of insulating resin base are exemplified. Examples thereof include polyolefins such as polyethylene (PE) and polypropylene (PP); polyesters such as polyethylene terephthalate (PET), polybutylene terephthalate (PBT), polyethylene naphthalate (PEN) and polybutylene naphthalate (PBN); polyvinyl chloride (PVC); polycarbonate (PC); polytetrafluoroethylene (PTFE); polyamide (PA); polyimide (PI); polyphenylene sulfide (PPS); and the like. A material that configures the adhesive layer is not particularly limited, and a variety of acrylic resins, a urethane resin, rubber and synthetic resin materials such as a silicone resin are exemplified.

The insulating tape 56 covers the first end portion 521 and is attached onto the positive electrode active material layers 54. Here, “covering the first end portion 521” does not only mean that the first end portion 521 is fully coated and the first end portion 521 is not allowed to be exposed to the outside but also means that at least 70% (for example, 80% or more, preferably 90% or more, more preferably 95% or more and still more preferably 98% or more) of the cross-sectional area of the first end portion 521 is not allowed to be exposed to the outside.

As shown in FIGS. 3 and 4, the insulating tape 56 has a first region 561 that faces the positive electrode sheet 50 and a second region 562 that does not face the positive electrode sheet 50. The first region 561 faces the positive electrode current collector 52 and the positive electrode active material layers 54 and is attached thereto through the adhesive layer 56b. In the second region 562, portions of the insulating tape 56 face each other in the laminate direction Z. That is, in the second region 562, portions of the base 56a face each other through the adhesive layer 56b in the laminate direction Z. The widths of the first region 561 and the second region 562 are both not particularly limited. These widths can be set to a width large enough to appropriately hold the insulating tape 56 on the positive electrode sheet 50 (that is, the positive electrode current collector 52 and the positive electrode active material layers 54).

A thickness D2 of the insulating tape 56 can be set to a thickness large enough to coat burrs present in the first end portion 521 of the positive electrode sheet 50 and to prevent the occurrence of a short-circuit attributed to the burrs. For example, the thickness D2 of the insulating tape 56 can be set to 0.1 times to one time the thickness of the positive electrode sheet 50. As an example, when the thickness of the positive electrode sheet 50 is 50 μm to 150 μm (for example, approximately 100 μm), and the thickness of the separator is 10 μm to 30 μm (for example, approximately 20 μm), the thickness D2 of the insulating tape 56 can be set to 30 μm to 50 μm (for example, approximately 40 μm).

A method for attaching the insulating tape 56 to the positive electrode sheet 50 is not particularly limited. For example, two insulating tapes 56 may be prepared and attached so as to sandwich the positive electrode sheet 50 in the laminate direction Z. Alternatively, one insulating tape 56 may be prepared and attached so as to sandwich the positive electrode sheet 50 in the laminate direction Z by doubling the insulating tape 56.

Incidentally, at the time of the initial charge of the secondary battery (herein, a lithium-ion secondary battery), a coating attributed to an additive for forming the coating (coating-forming agent) that is added to the non-aqueous electrolytic solution is formed. The coating possibly contains boron (B) or phosphorus (P) attributed to the coating-forming agent. The coating is ion-conductive, but is not electron-conductive. The formation of the coating makes the intercalation and deintercalation of lithium ions into and from the negative electrode active material smooth and suppresses excessive decomposition of the electrolytic solution. In the form shown in FIG. 4, the insulating tape 56 is stuck on the positive electrode active material layers 54 so as to cover the first end portion 521 of the positive electrode sheet 50 in the longitudinal direction Y. In this case, in a non-insulating tape-facing region 542 that is in the vicinity of an insulating tape-facing region 541 of the positive electrode active material layer 54, an interelectrode distance W1 between the positive electrode sheet 50 and the negative electrode sheet 60 increases compared with the interelectrode distances in other portions by the thickness of the insulating tape 56. A reference sign W2 in the figure indicates the interelectrode distance in the non-insulating tape-facing region 542.

That is, the interelectrode distance W1 between the positive electrode sheet 50 and the negative electrode sheet 60, that is, the gap between the positive electrode sheet 50 and the negative electrode sheet 60 widens by the difference (W2−W1) in the interelectrode distance caused by the insulating tape 56. As a result, an excess of the coating is formed locally on the negative electrode active material layer 64 facing the non-insulating tape-facing region 542. The present inventors assume that the reason for the excessive formation of the coating is that a large amount of the non-aqueous electrolytic solution flows into the portion where the gap between the positive electrode sheet 50 and the negative electrode sheet 60 becomes wide in the non-insulating tape-facing region 542. As a result, an unevenness in the formation of the coating may be caused on the negative electrode active material layer 64. The portion where the coating is excessively formed becomes a region having a higher resistance than other regions (high-resistance region), which possibly increases the positive electrode potential locally. Therefore, the positive electrode active material is eluted, and a positive electrode active material-derived metal is precipitated on the surface of the negative electrode active material layer 64 facing the vicinity of the portion where the insulating tape 56 is attached to the positive electrode active material layer 54. Furthermore, in the precipitation portion, metallic lithium is likely to be precipitated. Therefore, a phenomenon in which metallic lithium is precipitated on the surface of the negative electrode active material layer 64 facing the vicinity of the portion where the insulating tape 56 is stuck on the positive electrode active material layer 54 may occur. The inventors assume that the occurrence of the phenomenon of the precipitation of metallic lithium is attributed to the attachment of the insulating tape 56 to the positive electrode active material layer 54.

In the secondary battery 100 disclosed herein, as shown in FIGS. 3 and 4, the coating 58 is provided on the positive electrode active material layer 54 along the edge of the insulating tape 56. In this embodiment, the coating 58 is provided in close contact with the insulating tape 56. In addition, the coating 58 is continuously provided from one end portion to the other end portion of the positive electrode active material layer 54 in the width direction X of the positive electrode sheet 50. In addition, the coating 58 is provided only on the positive electrode active material layer 54 and is not provided on the positive electrode current collector 52.

As shown in FIG. 4, a thickness D1 of the coating 58 decreases gradually as a distance between the coating 58 and the edge of the insulating tape 56 increases gradually. Here, the thickness D1 is the distance from the surface of the positive electrode active material layer 54 to the upper end of the coating 58 in a cross-sectional view showing the laminate structure of the electrode body 20. The coating 58 is provided such that the thickness D1 gradually (smoothly) decreases gradually as the coating 58 comes closer to the center of the positive electrode sheet 50 in the longitudinal direction Y from the edge of the insulating tape 56. While not particularly limited, the maximum value of the thickness D1 of the coating 58 may be the same as the thickness D2 of the insulating tape 56 on the positive electrode active material layer 54-formed surface. That is, the coating 58 can be provided so as not to be present on the insulating tape 56.

A width L1 of the coating 58 formed can be appropriately set so as to smoothly absorb the thickness D2 of the insulating tape 56 and to realize the effect of the technique that is disclosed herein. For example, the width L1 of the coating 58 formed can be set to approximately 25 times to 75 times the thickness D2 of the insulating tape. As an example, when the thickness of the positive electrode sheet 50 is 100 μm, the thickness of the separator is 20 μm and the thickness D2 of the insulating tape 56 is 40 μm, the width L1 of the coating formed may be set to 1 mm to 3 mm (for example, approximately 1.5 mm).

The coating 58 is inactive to battery reactions. Here, the expression “inactive to battery reactions” refers to the fact that the coating 58 does not have any functions as an active material. The coating 58 may contain at least a resin binder. In such a case, it is possible to impart an appropriate viscosity for providing the coating 58 to a slurry for forming the coating 58. As an example, the coating 58 is a resin layer composed of a resin binder. As the resin binder, an insulating resin can be used without any particular limitations. Specific examples thereof include an acrylic resin; a vinyl halide resin such as polyvinylidene fluoride (PVDF); a polyalkylene oxide such as polyethylene oxide (PEO); styrene butadiene rubber (SBR); a polyolefin such as polyethylene (PE) or polypropylene (PP); a fluorine-containing resin such as polytetrafluoroethylene (PTFE); and the like.

In a case where the coating 58 is a resin layer, the coating 58 is preferably a resin layer composed of a resin binder, but may contain inevitable impurities other than a resin material. Here, the inevitable impurities other than a resin material refer to a variety of elements that are not included in the resin material that configures the resin layer. The mass proportion of the impurities in the coating 58 is, for example, less than 2% by mass, preferably less than 1% by mass and more preferably less than 0.5% by mass and is preferably as close to 0% by mass as possible.

Alternately, the coating 58 may be a filler layer containing an inorganic filler and a resin binder. As the inorganic filler, for example, an insulating or heat-resistant inorganic filler is used. In such an aspect, there is a case where the filler layer is referred to as “insulating layer” or “heat-resistant layer”. Examples of the inorganic filler include oxides such as alumina (Al₂O₃), magnesia (MgO), silica (SiO₂) and titania (TiO₂); nitrides such as aluminum nitride (AlN) and silicon nitride (SiN); hydroxides such as calcium hydroxide (CaOH₂), magnesium hydroxide (MgOH₂) and aluminum hydroxide (Al₂OH₃); clay minerals such as mica, talc, boehmite, zeolite, apatite and kaolin; glass fibers; and the like, and these inorganic fillers can be used singly or two or more inorganic fillers can be used in combination. The shape of the inorganic filler is not particularly limited and may be a particle shape, a fiber shape, a plate shape, a flake shape or the like. The average particle diameter of the inorganic filler is not particularly limited and may be, for example, 0.1 μm or more and 10 μm or less (preferably 0.5 μm or more and 5 μm or less). The average particle diameter of the inorganic filler can be obtained by, for example, a laser diffraction scattering method. As the resin binder, the above-described resin binder can be used.

In an aspect where the insulating tapes 56 and the coatings 58 are provided in both the first end portion 521 and the second end portion 522, the kinds of the coatings 58 at both ends may be the same as or different from each other. For example, both the first end portion 521 and the second end portion 522 may be provided with filler layers or may be provided with resin layers. Alternately, the first end portion 521 may be provided with a filler layer, and the second end portion 522 may be provided with a resin layer. What has been described above is also true for the kinds, dimensional relationships or the like of the tapes 56 in both end portions.

In the secondary battery that is disclosed herein, as shown in FIG. 4, the coating 58 that is inactive to battery reactions is provided on the positive electrode active material layer 54 along the edge of the insulating tape 56. The coating 58 fills the gap where the interelectrode distance between the positive electrode sheet 50 and the negative electrode sheet 60 has become wide due to the insulating tape 56. As a result, the unevenness in the formation of the coating on the negative electrode active material layer 64 is suppressed, and the amount of metallic lithium precipitated on the negative electrode active material layer 64 is suppressed.

In an aspect of the technique that is disclosed herein, the coating 58 may be a filler layer. When the coating 58 is a filler layer, the coating 58 is impregnated with the electrolytic solution. This makes it possible for lithium ions to migrate between the positive and negative electrodes through the filler layer. Lithium ions can be supplied to the negative electrode active material layer 64 facing the filler layer (coating 58), and the negative electrode active material layer 64 facing the filler layer (coating 58) is also capable of contributing to battery reactions. In addition, since the elution of the positive electrode active material from the portion where the coating 58 is formed on the positive electrode active material layer 54 is suppressed, the precipitation of metallic lithium on the negative electrode active material layer 64 is suppressed. In addition, in another aspect, the coating 58 may be a resin layer. In this case, since the elution of the positive electrode active material from the portion where the coating 58 is formed on the positive electrode active material layer 54 is suppressed, the precipitation of metallic lithium on the negative electrode active material layer 64 can be more reliably suppressed.

While not particularly limited, the coating distribution state in the negative electrode active material layer 64 can be investigated by, for example, laser ablation ICP mass spectrometry (LA-ICP-MS). For example, the coating distribution state can be analyzed by performing a line analysis on the negative electrode active material layer regarding the elements (for example, boron (B), phosphorus (P) and the like) that are contained in the coating formed on the negative electrode active material layer. As an LA-ICP-MS device, a well-known conventional device, for example, UP213 manufactured by New Wave Research, Inc. may be used.

The secondary battery 100 can be used in a variety of uses. As preferable uses, power supplies for driving that are mounted in vehicles such as a battery electric vehicle (BEV), a hybrid electronic vehicle (HEV) and a plug-in hybrid electronic vehicle (PHEV) are exemplified. In addition, the secondary battery 100 can be used as a storage battery for small-sized power storage devices. Typically, the secondary battery 100 can also be used in a form of an assembled battery where a plurality of the secondary batteries 100 is connected in series and/or in parallel.

### EXAMPLES

Hereinafter, examples relating to the present invention will be described, which is not intended to limit the present invention to the following examples.

Production of Lithium Ion Secondary Batteries for Evaluation

Secondary batteries for evaluation according to Examples 1 to 3 were produced as described below.

### Example 1

LiNi_{1/3}Co_{1/3}Mn_{1/3}O₂ (LNCM) as a positive electrode active material, acetylene black (AB) as a conductive material and polyvinylidene fluoride (PVDF) as a binder were mixed in a mass ratio of 87:10:3 (LNCM:AB:PVDF) with N-methylpyrrolidone (NMP), thereby preparing a slurry for forming a positive electrode active material layer. In addition, an acrylic resin was dispersed in water such that the solid content rate reached 35%, thereby preparing a slurry for forming a coating. This slurry for forming a positive electrode active material layer was applied to both surfaces of a long sheet-shaped aluminum foil. After that, the slurry was dried to form positive electrode active material layers, and roll pressing was performed. In addition, the aluminum foil having the positive electrode active material layers formed thereon was cut to a desired size, thereby producing a positive electrode sheet.

In both end portions (that is, the cut portions) of this positive electrode sheet, insulating tapes were attached onto the positive electrode active material layers, and furthermore, both end portions were covered with the insulating tapes. Next, the slurry for forming a coating was added dropwise along the insulating tapes using a syringe and dried, thereby forming coatings (acrylic resin layers).

Graphite (C) as a negative electrode active material, styrene butadiene rubber (SBR) as a binder and carboxymethyl cellulose (CMC) as a viscosity improver were mixed in a mass ratio of 98:1:1 (C:SBR:CMC) with ion exchange water, thereby preparing a slurry for forming a negative electrode active material layer. This slurry was applied to both surfaces of a long sheet-shaped copper foil. After that, the slurry was dried to form negative electrode active material layers, and roll pressing was performed. In addition, the copper foil having the negative electrode active material layers formed thereon was cut to a desired size, thereby producing a negative electrode sheet.

A porous polyolefin sheet having a three-layer structure of PP/PE/PP was prepared as a separator sheet.

The positive electrode sheet and the negative electrode sheet, which had been produced above, and two separators, which had been prepared, were laminated and wound, and the laminate was pressed in a side surface direction to be squashed, thereby producing a flat wound electrode body. Next, a positive electrode terminal and a negative electrode terminal were connected to the wound electrode body, and the wound electrode body was accommodated in a square battery case having an electrolytic solution injection port. Subsequently, a non-aqueous electrolytic solution was injected from the electrolytic solution injection port of the battery case, and the injection port was airtightly sealed. As the non-aqueous electrolytic solution, a solution prepared by dissolving LiPF₆ as a supporting electrolyte in a solvent mixture containing ethylene carbonate (EC), ethylene methyl carbonate (EMC) and dimethyl carbonate (DMC) in a volume ratio, i.e., EC:EMC:DMC=3:4:3, in a concentration of 1.1 mol/L was used. A secondary battery for evaluation was produced as described above.

### Example 2

As a slurry for forming a coating, a slurry containing polyvinylidene fluoride (PVDF) dissolved in N-methylpyrrolidone (NMP) such that the mass proportion in the N-methylpyrrolidone (NMP) reached 5% by mass was prepared and used. A secondary battery for evaluation according to Example 2 was produced using the same materials and the same order as in Example 1 except the above-described fact.

### Example 3

A secondary battery for evaluation according to Example 3 was produced using the same materials and the same order as in Example 1 except the fact that no coatings were formed.

Evaluation of Precipitation of Metallic Lithium

An activation treatment was performed on the secondary batteries for evaluation under predetermined conditions, thereby acquiring initial capacities. Such initial capacities were 4 Ah. An aging treatment was further performed on the secondary batteries for evaluation. The secondary batteries for evaluation were adjusted to a SOC of 80% and placed in an environment of 0° C. A charge and discharge cycle including 10-second constant current charge at 20C and 20-second constant current discharge at 10C as one cycle was repeatedly performed on these secondary batteries 1000 cycles. Between the charge and the discharge, a down time of three minutes was provided. After that, each of the secondary batteries for evaluation was disassembled, the negative electrode sheet was removed, a part of the end portion of the negative electrode active material layer facing the insulating tape provided on the positive electrode sheet was cut out, and the presence or absence of the precipitation of metallic lithium was visually checked and analyzed by an electron spin resonance method (ESR). In addition, the amount of lithium precipitated was determined from the peak intensity near 3445 G. The results are shown in Table 1. The value “No” in the “Li precipitation” column of Table 1 indicates that no metallic lithium was detected even by the ESR analysis.

TABLE 1

| | Resin binder | Li precipitation |
|---|---|---|
| Example 1 | Acrylic resin | No |
| Example 2 | PVDF | No |
| Example 3 | — | Yes |

As shown in Table 1, in the secondary batteries for evaluation according to Examples 1 and 2 where the coatings were formed along the insulating tapes stuck on the end portions of the positive electrode sheet in the longitudinal direction, the precipitation of metallic lithium after the charge and discharge cycles was suppressed. On the other hand, in the secondary battery for evaluation according to Example 3 where the coatings were not formed, the precipitation of metallic lithium was observed after the charge and discharge cycles in the negative electrode sheet.

From the above-described facts, it was confirmed that, in a secondary battery having a configuration in which a wound electrode body in which a positive electrode sheet having a long sheet-shaped positive electrode current collector and a positive electrode active material layer formed on the surface of the positive electrode current collector and a negative electrode sheet having a long sheet-shaped negative electrode current collector and a negative electrode active material layer formed on the surface of the negative electrode current collector are wound in the longitudinal direction with a separator interposed therebetween and a non-aqueous electrolytic solution are provided, an insulating tape that covers at least an end portion of the positive electrode sheet in the longitudinal direction and is attached onto the positive electrode active material layer and a coating that is provided on the positive electrode active material layer along an edge of the insulating tape and is inactive to a battery reaction are provided, and the thickness of the coating decreases gradually as the distance between the coating and the edge of the insulating tape increases gradually, the precipitation of metallic lithium on the negative electrode active material is suppressed.

Hitherto, specific examples of the technique that is disclosed herein have been described in detail. However, these are merely examples and do not limit the scope of the claims. The technique that is disclosed herein includes a variety of modifications and changes of the above-described specific examples. For example, the technique that is disclosed herein can also be applied to sodium-ion secondary batteries.

In the above-described embodiment, the coating 58 and the insulating tape 56 are in close contact with each other as shown in the figures. The coating 58 is continuously provided from one end portion to the other end portion of the positive electrode active material layer 54 in the width direction X. The coatings 58 are provided only on the positive electrode active material layers 54. However, the technique that is disclosed herein is not limited thereto. That is, as long as the effect of the technique that is disclosed herein can be realized, there may be a fine gap between the coating 58 and the insulating tape 56. As long as the effect of the technique that is disclosed herein can be realized, the coating 58 may not be continuously formed. A region where the coating 58 is not formed may be partially present in the region along the edge of the insulating tape 56 on the positive electrode active material layer 54. The coating 58 may be provided on the positive electrode current collector 52 (positive electrode active material layer-free portion 52a).

What is claimed is:

1. A secondary battery comprising:
a wound electrode body in which a positive electrode sheet comprising a long sheet-shaped positive electrode current collector and a positive electrode active material layer formed on a surface of the positive electrode current collector, and a negative electrode sheet comprising a long sheet-shaped negative electrode current collector and a negative electrode active material layer formed on a surface of the negative electrode current collector are wound in a longitudinal direction, with a separator being interposed therebetween; and
a non-aqueous electrolytic solution,
wherein
at least one end portion of the positive electrode sheet in the longitudinal direction is provided with
an insulating tape that covers the end portion and is attached onto the positive electrode active material layer, and
a coating that is provided on the positive electrode active material layer along an edge of the insulating tape and is inactive to a battery reaction,
and
a thickness of the coating decreases gradually as a distance between the coating and the edge of the insulating tape increases gradually.

2. The secondary battery according to claim 1, wherein
the insulating tape and the coating are provided at both ends of the positive electrode sheet in the longitudinal direction.

3. The secondary battery according to claim 1, comprising, as the coating,
a filler layer comprising an inorganic filler and a resin binder, and/or
a resin layer composed of a resin binder.

4. The secondary battery according to claim 3, wherein
the resin binder comprises at least one resin material selected from the group consisting of an acrylic resin and a vinyl halide resin.
